(19) United States
(12) Patent Application Publication
(10) Pub. No.: US 2022/0368768 A1
(43) Pub. Date: Nov. 17, 2022

(54) CONTEXT-BASED USER STATUS INDICATOR SELECTION

(71) Applicant: Apple Inc., Cupertino, CA (US)

(72) Inventors: Austin A. MARUSCO, San Francisco, CA (US); Benjamin W. BROWN, Cupertino, CA (US); Chiraag SUMANTH, Sunnyvale, CA (US); Gokcen CILINGIR, Cupertino, CA (US); Joseph E. MEYER, Fremont, CA (US); Rafael Marques MARTINS, Campbell, CA (US); Roberto GARCIA, Cupertino, CA (US); Sara QIAM, San Francisco, CA (US)

(21) Appl. No.: 17/492,530

(22) Filed: Oct. 1, 2021

Related U.S. Application Data
(60) Provisional application No. 63/189,668, filed on May 17, 2021.

(51) Int. Cl. H04L 29/08; G06N 5/04; G06N 5/02

(52) U.S. Cl. CPC H04L 67/22; G06N 5/04; G06N 5/022

(57) ABSTRACT

The subject technology provides systems and methods for context-based user status indicator selection. In an example, a method includes obtaining, by a first electronic device associated with a first user, status indicators, each of which indicates a respective status of a second user of a second electronic device. Furthermore, the method includes determining, by the first electronic device, a respective relevance priority of each of the status indicators. Based on the determined respective priorities, a subset of the status indicators is selected by the first electronic device and is displayed in a graphical element on the first electronic device.

### CROSS REFERENCE TO RELATED APPLICATIONS

This application claims the benefit of priority to U.S. Provisional Patent Application No. 63/189,668, entitled “CONTEXT-BASED USER STATUS INDICATOR SELECTION,” filed on May 17, 2021, the disclosure of which is hereby incorporated herein in its entirety.

### TECHNICAL FIELD

The present description relates to user status indicator selection, including context-based user status indicator selection.

### BACKGROUND

Users may interact with each other using electronic devices, such as smartphones, tablets, laptops, etc. A user of an electronic device may set a status that is visible to other users. The status may indicate, for example, that the user is available, busy, in a meeting, and the like. Other users may view the user's status and may determine, for example, whether it would be appropriate to initiate contact with the user.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates an example network environment in accordance with one or more implementations of the subject technology.

FIG. 2 illustrates an example system, in accordance with one or more implementations of the subject technology.

FIG. 3 illustrates an example display of recommended contacts, in accordance with one or more implementations of the subject technology.

FIG. 4 illustrates an example graphical element, in accordance with one or more implementations of the subject technology.

FIG. 5 illustrates an example contact card that may include status information for a contact, in accordance with one or more implementations of the subject technology.

FIG. 6 illustrates example relevance priority curves, in accordance with one or more implementations of the subject technology.

FIG. 7 illustrates a flowchart of a process for context-based user status indicator selection, in accordance with one or more implementations of the subject technology.

FIG. 8 depicts a computing-device based implementation of the system of FIG. 2 in accordance with one or more implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the present description relate to selecting and providing, via a graphical element displayed by electronic device of a user, the status of one or more other users of other electronic devices. In one or more implementations of the subject technology, an electronic device of a first user may obtain status indicators associated with several different types of statuses of a second user of another electronic device. The status indicators may each be indicative of a respective type of the statuses of the second user. For example, the type of statuses may include, but are not limited to, a login status, a location status, a travel activity status, an approval request status, and the like. In one or more implementations, the electronic device of the first user may determine a relevance priority of each of the status indicators for the second user, such as, for example, based on a context of the user and/or a context of the second user. Based on the determined relevance priorities, one or more status indicators may be selected for display in a graphical element on the electronic device such that the user is provided with one or more relevant type of statuses corresponding to the second user.

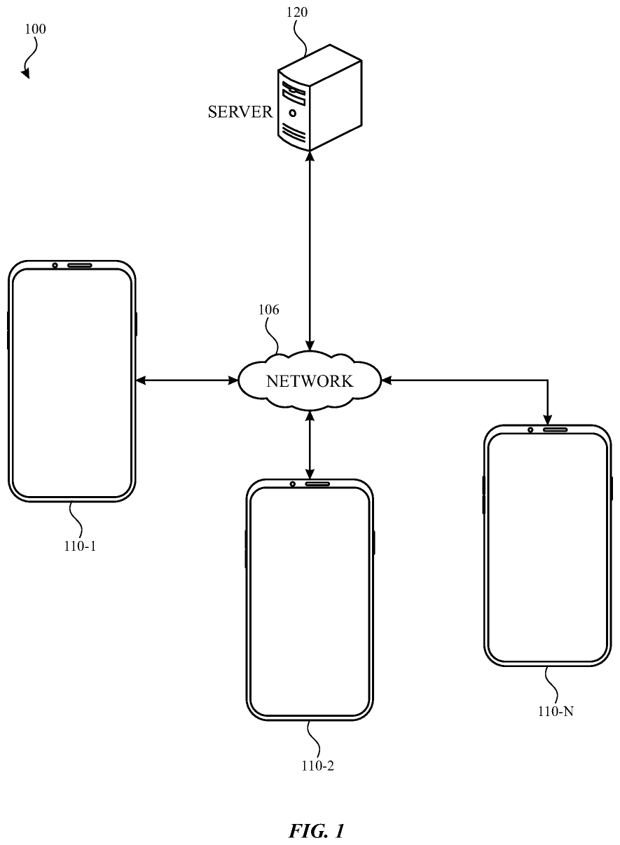

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes a network 106, and one or more electronic devices such as electronic devices 110-1 to 110-N, hereinafter collectively referred to as “electronic devices 110”, and a server 120. The network 106 may communicatively (directly or indirectly) couple two or more of the electronic devices 110 and/or the server 120. In one or more implementations, the network 106 may be an interconnected network of devices that may include, or may be communicatively coupled to, the Internet. For explanatory purposes, the network environment 100 is illustrated in FIG. 1 as including three electronic devices 110, and the server 120; however, the network environment 100 may include any number of electronic devices and any number of servers.

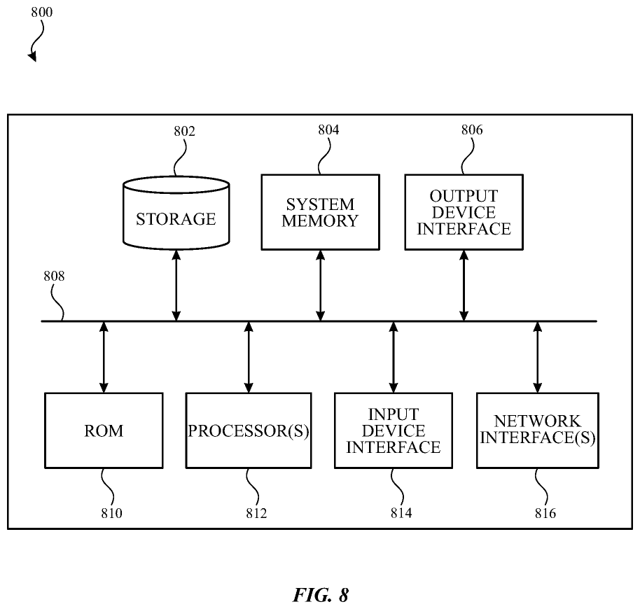

Each of the electronic devices 110 may be, for example, a desktop computer, a portable electronic device such as a laptop computer, a smartphone, a peripheral device (e.g., a digital camera, headphones), a tablet device, a wearable device such as a watch, a band, and the like. The electronic device 110 may be, and/or may include all or part of, the electronic system discussed below with respect to FIG. 8.

In one or more implementations, the electronic device 110 may provide a system for training a machine learning model using training data, where the trained machine learning model is subsequently deployed locally at the electronic device 110. Further, the electronic device 110 may provide one or more machine learning frameworks for training and/or executing machine learning models. In an example, such machine learning frameworks can provide various machine learning algorithms and/or models for different problem domains in machine learning. In an example, the electronic device 110 may include a user electronic device that displays status indicators on a graphical element thereon. The electronic device 110 may communicate with a server 120 (e.g., a back-end server) for obtaining and/or processing status indicators and/or associated data using one or more machine learning models.

In an implementation, the server 120 may train one or more machine learning models for deployment to a client electronic device (e.g., the electronic device 110). In other implementations, the server 120 may provide a system for training a machine learning model using training data, where the trained machine learning model is subsequently deployed locally at the server 120. The machine learning model may be deployed on the server 120 and/or the electronic device 110 may then perform one or more machine learning algorithms. In an implementation, the server 120 may provide a cloud service that utilizes the trained machine learning model.

In an example, the electronic device 110-1 may be operated by, and be associated with a first user. In the present description, the electronic device 110-1 of first user may be referred to as the first electronic device 110-1. In one or more implementations of the subject technology, the first electronic device 110-1 may include a system process which may be configured to obtain status indicators associated with a second user of a second device. In an example, each of the status indicators may indicate a respective status of the second user of a second electronic device 110-2. Examples of the type of statuses of the second user that may be indicated by a status indicator may include, but are not limited to, an availability status, a location status, an approval request status, and the like.

In one or more implementations, an availability status may be indicative of the availability of the second user. For instance, the second user may be in a meeting and may accordingly have an availability status of: busy. Other availability statuses may include, for example, exercising, driving, gaming, listening to music, on a call, sleeping, do not disturb, or generally any availability status. Thus, in one or more implementations, the availability status of the second user that is displayed in the graphical element on the first electronic device 110-1 may indicate that the second user is busy.

In one or more implementations, a location status may indicate the details of a location of the second user. This location, in an example, may be a current location of the second electronic device 110-2 or may be a last known location of the second electronic device 110-2 (and/or another electronic device of the second user). For instance, the second user may be in a coffee shop in San Francisco. Thus, the location status indicator may indicate that the second user is in San Francisco or may show more specific location such as location of the coffee shop in San Francisco.

In one or more implementations, an approval request status may include details of a request made by the second user using the second electronic device 110-2 to the first user of the first electronic device 110-1 to complete a transaction. For instance, consider an example where the first user is a parent and the second user is a child who is using a payment source (e.g., a credit card or other electronic payment mechanism) that is linked to the parent, and accordingly all payment requests are to go to the electronic device 110-1 of the parent. In such a case, when the child initiates a purchase, the purchase status of the second user may be sent to the electronic device 110-2 of the parent. This purchase status may be displayed to the parent using the approval request status indicator, in an example. In one or more implementations, the approval request status may also be used for any other approvals requested by the second user, such as approval for access to a particular application, and/or for additional time using a particular application.

The first electronic device 110-1 may determine a relevance priority of each of the status indicators. Based on the determined respective relevance priorities, the first electronic device 110-1 may select a subset of the status indicators for display to the user. This selected subset of status indicators may then be displayed on one or more graphical elements on the first electronic device 110-1. The number of status indicators included in the subset of status indicators for display may depend on the amount of space available for display of the status indicators on the graphical element.

In one or more implementations, the graphical element displaying the subset of the status indicators may be a widget. A ‘widget’ may be understood, for example, to be a graphical element that is persistently displayed or accessible for display overlaid on a portion of a home screen or other screen of a device operating system. The widget may display, for example, a subset of available information for an underlying application for which the full user interface of the application is not currently active and/or fully active. For example, the widget may be a widget of a contacts application that displays contact information for a subset (e.g., one, two, or three or more) of a large number contacts stored at the device, the particular subset of contacts and/or the particular contact information having been determined to be potentially relevant to the user of the device at the current time.

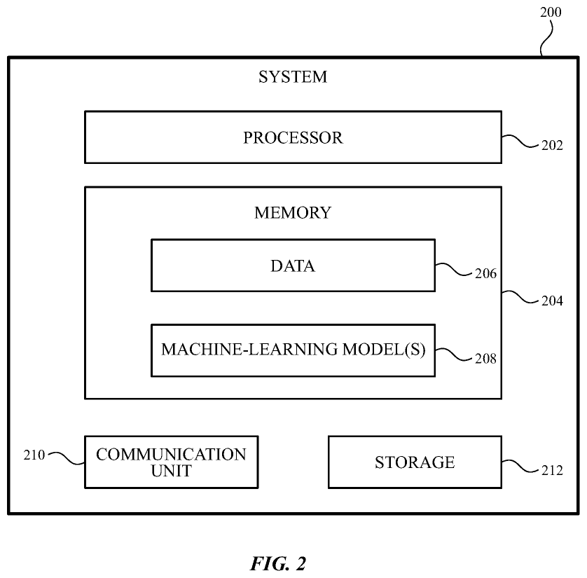

FIG. 2 illustrates an example system 200 in accordance with one or more implementations of the subject technology. In an example, the system 200 may be implemented in one or more computing devices, such as the first electronic device 110-1 or any of the other electronic devices 110. In another example, the system 200 may be implemented either in a single device or in a distributed manner in a plurality of devices.

In an example, the system 200 may include a processor 202, and memory 204 (memory device) and a communication unit 210. The memory 204 may store one or more data structures 206 and one or more machine learning models 208. In an example, the system 200 may include or may be communicatively coupled with a storage 212. Thus, the storage 212 may be either an internal storage or an external storage.

In an example, the processor 202 may be a single processing unit or a number of units, all of which may include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The one or more data structures 206 serve, amongst other things, as a repository for storing data processed, received, and/or generated by one or more of the processor 202. One or more of the aforementioned components of the system 200 may send or receive data, for example, using one or more input/output ports and one or more communication units.

The machine-learning (ML) model(s) 208, in an example, may include and/or be based on a neural network architecture, or other machine-learning architecture. In an example, the machine-learning model(s) 208 may be implemented by the processor 202 for performing one or more of the operations and steps, as described herein. For instance, an ML model 208 may be used to make contact recommendations to the first user of the first electronic device 110-1. The contact recommendations include details associated with one or more contacts which the first user may select using the first electronic device 110-1, for receiving status indicators associated with the one or more contacts. In an example, the ML model 208 may generate an output including contact recommendations, based on inputs to the model that indicate interactions between the first user and the one or more contacts and/or one or more relationships between the first user and the one or more contacts.

In an example, the communication unit 210 may include one or more hardware units that support wired or wireless communication between the processor 202 and processors of other electronic devices.

In one or more implementations, the processor 202 of the first electronic device 110-1 may be configured to obtain status indicators, each of which indicates a respective status of the second user of the second electronic device 110-2. In an example, the processor 202 may obtain the status indicators directly from the second electronic device 110-2, from the second electronic device 110-2 via the server 120, and/or may locally determine the one or more status indicators based on, for example, a text message or other communication or interaction received from the second electronic device 110-2.

In one or more implementations, the processor 202 may determine one or more status indicators based on chat messages exchanged between the first user and the second user. For instance, the processor 202 may receive a text message from the second electronic device 110-2, stating “I'm going to be at the gym from 2-3 today”. Based on the text message, the processor 202 may determine that the location status may be a gym that is frequented by the first user and/or the second user, and the availability status may be busy between 2 μm and 3 pm on the day of the chat messages. In another example implementation, the processor 202 may determine the status indicator based on a calendar or a meeting invite shared by the second electronic device 110-2 with the first electronic device 110-1. In another example implementation, the status indicators may be generated by the second electronic device 110-2 and provided from the second electronic device 110-2 to the first electronic device 110-1.

In further example implementations, the processor 202 may communicate with the second electronic device 110-2 for obtaining the status indicators. The second electronic device 110-2 may be configured to transmit information about the status indicators to the first electronic device 110-1.

The processor 202 may be configured to (e.g., subsequent to the obtaining of the status indicators) determine a respective relevance priority of each of the status indicators. In an example, the processor 202 may obtain a relevance priority curve corresponding to the status indicator. For example, for a location status indicator, the relevance priority curve may indicate a relevance priority of the second user's current location as a function of distance from the first user's location, or from another location associated with the first user (e.g., a recently visited location, a frequently visited location, or a location mentioned in message to the second user or other user).

As another example, when a status indicator of any of various status types changes, the relevance priority curve for that status type may indicate a decreasing relevance priority of the status as a function of time since the status change. In another example, (e.g., in scenarios in which the first user and the second user are associated with a common group account such as a family account or a home network) the status indicator may indicate that the second user is in the process of making a purchase with a payment tool that is shared with the first user (e.g., the first user's child may be attempting to rent a movie or order a delivery using a credit card of the first user) by the processor 202. The processor 202 may obtain a relevance priority curve that indicates relevance priority as a function of purchase price or movie rating (e.g., to notify the first user of an imminent high cost or inappropriate purchase by the first user's child).

In an example, the relevance priority curve may indicate a relevance priority level of the status indicator as a function of time (e.g., as a function of different times during a day or as a function of time since an event associated with the status commenced, or as a function of time since status change of the status indicator), and may be defined by a start score, an end score, and a relevance priority score curve that extends from the start score to the end score in a predetermined manner. Furthermore, the relevance priority curve of one or more of the status indicators may be different for each day of the week. As an example, consider the relevance priority curve for status indicator: availability. For example, the first user may have a workday that extends from 9 AM to 6 PM. In this example, the relevance priority curve for availability statuses of coworkers of the user may indicate high priority e.g., during the time period between 9 AM to 6 PM, on weekdays, and a low priority for coworker statuses before 9 AM and after 6 PM on weekdays, and on weekends.

In one or more implementations, the relevance priority curve may be correlated to and/or modified according to user activity of the first user. For instance, the relevance priority for displaying various types of statuses of various other users may be further determined on the basis of whether and/or how the first user is occupied (e.g., is driving, is playing, etc.). For example, the relevance priority curve of the status indicators may be modified. For instance, the processor 202 may determine that the first user is in a gym, for example, based on a location of the first electronic device 110-1 or based on user activity data collected using a connected wearable device. The processor 202 may determine that the status indicators of other various users who are at the gym may be relevant to the first user. Accordingly, the relevance priority of the location status indicators of such users may be increased, in a predetermined manner. Likewise, in an example, one or more other users may have a location which is nearby to the location of the gym where the first user is present. The relevance priority of the location status indicator of such contacts may be increased.

In an example, for determining the relevance priority of a given status indicator, the processor 202 may be configured to obtain a time associated with the given status indicator. This time may be a time instant at which the status indicator was obtained, when a status corresponding to the status indicator changed, or when an activity associated with the status indicator began or ended. Based on the time, the processor 202 may be configured to extract the relevance priority from the obtained relevance priority curve corresponding to the status type of the status indicator.

In a similar manner as described above, the relevance priority of each of the status indicators received for each of one or more other users may be determined by the processor 202. Once the priorities are determined, the processor 202 may select a subset of the status indicators for display, based on the determined respective priorities. In an example, the processor 202 may compare the determined priorities with a predefined threshold and only those status indicators whose corresponding relevance priority is above the threshold may be included in the subset. In another example, the status indicators with the two, three, four, five, or more highest priorities may be displayed. In one or more implementations, the threshold may differ depending upon the current status of the user of the first electronic device.

Once the subset is selected, the processor 202 may display the subset of the status indicators in a graphical element on the first electronic device. In an example, the graphical element may be a widget. In this example, the subset of the status indicators may be displayed in a contact element associated with the second contact. The contact element may be in a graphical form such as a badge and/or an icon and may include one or more selectable elements corresponding to the status indicators. On selection of a selectable element, details of corresponding status indicator may be displayed on the first electronic device 110.

In one or more implementations, a selection of the second user for inclusion in the status indicators in the graphical element may be performed either automatically or based on a user input. For instance, in an example, the first user may manually open the graphical element and add the second user in the graphical element.

In another example, the processor 202 may suggest contacts for inclusion in the status graphical element. For example, the processor 202 may provide local data associated with users corresponding to contacts stored at the first electronic device 110 as an input to a machine learning model, such as an ML model 208. The machine learning model may be trained to determine the relevance, to the first user, of the contacts of the first user. In an example, the machine learning model may determine the relevance of a contact to the first user based on one or more of a relation determination between the first user and the contact, a number and/or frequency of communication exchanges between the first user and the contact, a number and/or frequency of interactions (e.g., social media interactions) between the first user and the contact, and other such interactive channels may be considered. The machine learning model may output the contact of second user as a relevant contact. Based on this output, the processor 202 may recommend the selection of the second user to the first user for inclusion of status information in the graphical element. The processor 202 may receive an acceptance of the recommendation at the first electronic device 110 from the first user.

In an example implementation, for suggesting the contacts that may be included in the graphical element, the processor 202 may implement a contact identification model that has been trained to identify potential contacts for including in the graphical element for displaying on a home screen of the first electronic device 110-1, using local information at the first electronic device 110-1. The contact identification model may be trained, for example, using training data that correlates particular user behavior patterns with significant contacts of a user. For example, the training data may indicate whether a particular contact is a significant contact based on one or more of a relation determination between the first user and the contact, a number and/or frequency of communication exchanges between the first user and the contact, a number and/or frequency of interactions (e.g., social media interactions) between the first user and the contact, and the like.

In one or more implementations, first electronic device 110-1 may store contacts and contact information. The contacts and/or the contact information may be provided to the contact identification model to obtain one or more suggested contacts from the contacts. For example, the output of the candidate identification model may be a binary label for each contact for which contact information was provided to the model. Although candidate identification model is described as a single machine learning model, it should be appreciated that candidate identification model can incorporate an ensemble of models that provide outputs that can be merged to output one or more potential group members.

In one or more implementations, the first electronic device 110-1 may include a pre-filter that pre-filters the contacts and/or the contact information prior to providing the contacts and/or the contact information to the candidate identification model. For example, the pre-filter may reduce the number of contacts (and the associated contact information) that are provided to the candidate identification model, based on the contact information.

Contact information may include contact features in various categories of features for one or more of contacts in the first electronic device 110-1, for which evidence of the presence of these features can be found at electronic device. For example, data associated with contacts and/or activity at the first electronic device 110-1 can be pre-processed to form contact information, which may include interaction features that describes interactions (e.g., over a predetermined period of time such as over the preceding week, weeks, month, months, six months, year, or years), and/or contact profile features that describe stored features of one or more of the contacts. The interaction information and/or the contact profile information may be extracted from the data stored at first electronic device 110-1 and/or provided to the candidate identification model to obtain one or more suggested contacts for inclusion in the graphical element, from the model.

Once the acceptance of a second user for inclusion on one or more graphical elements is received, the processor 202 may be configured to obtain the status indicators corresponding to the second user from the second user's device, and/or from an intermediary server. In an example, the processor 202 may obtain the status indicators periodically, say, after every half an hour. In another example, the processor 202 may obtain the updates upon launching of the graphical element by the first user at the first electronic device 110. In an example, the processor 202 may be configured to obtain and store the status indicators in the storage 212 and may obtain the obtained status indicators from the storage 212 when the graphical element is launched.

In various implementations, different type of statuses of any number of users may be included in the graphical element. For instance, in an example, the processor may be configured to obtain additional status indicators, each of which indicates a respective additional status of a third user of a third electronic device (e.g., electronic device 110-N). Thereafter, the processor 202 may determine an additional respective relevance priority of each of the additional status indicators, in a manner as explained above. Subsequently, the processor 202 may be configured to select an additional subset of the additional status indicators based on the determined additional respective priorities. The processor 202 may be configured to display the additional subset of the additional status indicators in the graphical element on the first electronic device 110. Thus, in this case, two contact elements, e.g., one for the second user and one for the third user may be displayed in the graphical element. In another example, the graphical element may include status indicators corresponding to a plurality of contacts, such that the status indicators and/or the contacts are sorted based on their respective relevance priority, with the status indicators of various contacts interspersed in the list of statuses.

In one or more implementations, the processor 202 may detect a status update event. The status update event may be received from the second user's device and/or an intermediary server. For instance, the second user or the second user's device may update a status, for example, from busy to free. The processor 202 may be configured to update the relevance priority for the status type based on the status update event (e.g., using a time-dependent relevance priority curve). If the updated relevance priority exceeds the threshold, the processor 202 may include the status indicator in the graphical element.

Thus, aspects of the present subject matter provide for a convenient and less convoluted methodology for the first user to obtain status information about contacts. This provides for saving on computing and network resources as the need for the first user to access different channels individually may be averted. Furthermore, as the status information provided is relevance priority driven, relevant information about the contact is provided to the first user when the information is relevant to the first user.

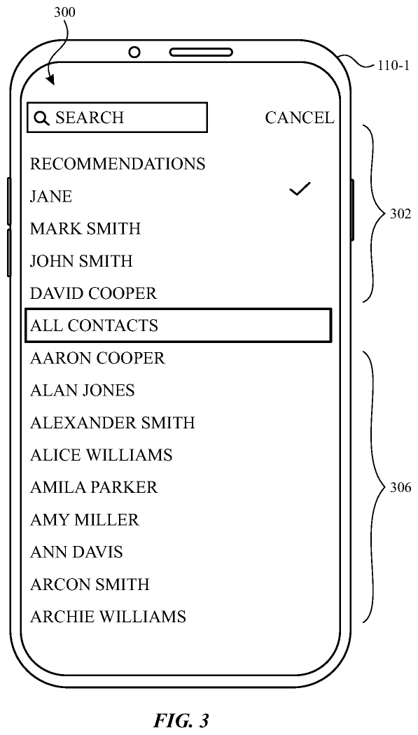

FIG. 3 illustrates an example contacts list 300 for contacts stored by the electronic device 110-1, in accordance with one or more implementations of the subject technology. As shown in the figure, the contacts list 300 may include set of contacts 302 which includes recommendations of contacts of the first user for inclusion in a contacts status indicator graphical element (e.g., recommendations as generated by an ML model such as ML model 208 and/or the contact identification model explained above). The first user may select one or more contacts from the recommendations in the set of contacts 302 for inclusion in the contact status indicator graphical element. The contacts list 300 further includes a list 306 of all of the contacts stored by the electronic device 110-1. The first user may select one or more contacts from the list 306 for inclusion in the contacts status indicator graphical element. The contacts list 300 may be displayed, for example, when the user of the electronic device 110 selects an option to add a contact to a graphical element such as a contacts widget.

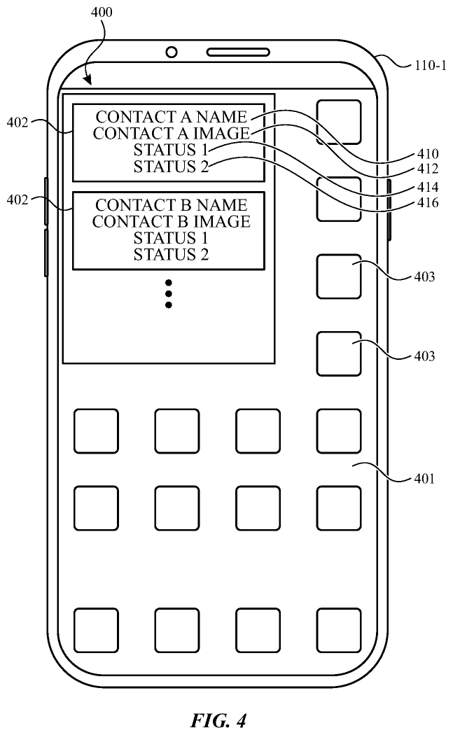

FIG. 4 illustrates an example of a graphical element 400, in accordance with one or more implementations of the subject technology. In the example of FIG. 4, the graphical element 400 is displayed within a portion of a home screen 401 of the electronic device 110-1. However, in other implementations, the graphical element 400 may be displayed as a portion of a another home screen of the electronic device, or may be accessed by navigating to the graphical element 400 (e.g., by swiping right or left past an outermost home screen 401 of a device).

In the example of FIG. 4, the graphical element 400 is of rectangular shape. In other examples, the graphical element 400 may be of any suitable shape, size or form. As shown in the example of FIG. 4, the graphical element 400 may be displayed over or among application icons 403 (e.g., icons associated with shortcuts for activating corresponding applications) that are also displayed within the home screen 401. In one or more implementations, the graphical element 400 may be displayed on the home screen 401 such that other applications are automatically moved from the portion covered by the graphical element 400. In the example of FIG. 4, the graphical element 400 is displayed in a top left corner of the home screen 401 of the electronic device 110. However, it is appreciated that the graphical element 400 can be displayed at any suitable location in the home screen 401 or as a portion, for example, of a widget screen of the electronic device.

In an example, the graphical element 400 may include one or more status indicators corresponding to each of one or more contacts, within the boundaries of the graphical element 400. In an example, a status indicator from the one or more status indicators may indicate availability of a contact. In another example, a status indicator from the one or more status indicators may indicate a location of a contact. In yet another example, a status indicator from the one or more status indicators may indicate details related to an approval request of a contact.

As shown in FIG. 4, in one or more implementations, the graphical element 402 may include a contact element 402 for each of one or more contacts. As shown in FIG. 4, each contact element 402 may include information that identifies a contact (e.g., a contact name 410 and/or a contact image 412 such as a photo of the contact or an avatar or other image associated with the contact), and one or more status indicators (e.g., a first status indicator 414 and a second status indicator 416) corresponding to the contact, displayed within a boundary of the contact element 402. For example, first status indicator 414 and the second status indicator 416 for each contact may be a subset of multiple of status indicators that are available for that contact. For example, the first status indicator 414 and the second status indicator 416 for each contact may be a subset of multiple of status indicators that have been selected based on the determined respective priorities for each status indicator. For example, for a first contact, the first status indicator 414 may be a location status indicator, and the second status indicator 416 may be an availability status indicator (e.g., busy or available). For a second contact, the first status indicator 414 may be a status indicator, and the second status indicator 416 may be a purchase indicator (e.g., indicating that the second contact is about to make a purchase using a payment tool associated with the user of the electronic device).

As indicated in FIG. 4, additional contact elements 402 for additional contacts may also be accessible within the graphical element 400 (e.g., by scrolling down or up through a list of contact elements 402, each corresponding to a contact). In one or more implementations, the order of the contact elements 402 in the graphical element 400 and/or which contact elements 402 are displayed in the graphical element 400 at a particular time may also be determined based on relative determined priorities of the type of statuses of the corresponding contacts and/or based on information indicating a relative importance of the corresponding contacts to the user (e.g., based on inclusion of the contact in a family group, a work group, or based on a frequency and/or recency of interactions with the contact).

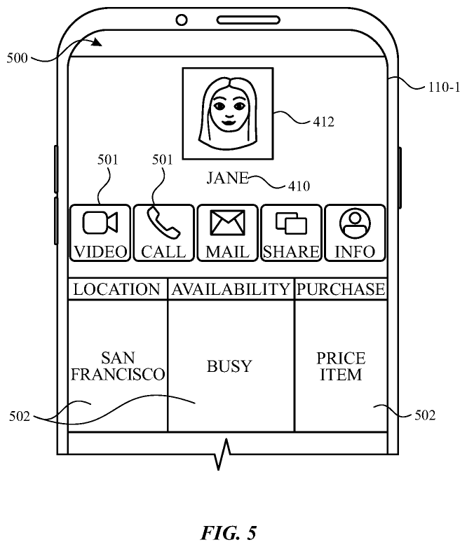

In one or more implementations, a contact element 402 may be selected to display additional details related to the corresponding contact (e.g., as shown and explained in greater detail in reference to FIG. 5).

FIG. 5 illustrates an example of a contact card 500 that may be displayed when a contact element 402 of FIG. 4 is selected, in accordance with one or more implementations of the subject technology. For example, the contact card 500 may be provided within a user interface of a contacts application, and may be or include more detailed or expanded information for the contact associated with the contact element 402. Upon selection of the contact element 402, for example, by a user of the first electronic device 110-1 based on a user input, the contact card 500 may be displayed by the first electronic device 110-1. As shown in the example of FIG. 5, the contact card 500 may include one or more selectable elements 501 that may be used to interact with the contact (e.g., by phone call, by message, by social media application, by video call, etc.).

As shown in the example of FIG. 5, the contact card 500 may include one or more selectable elements 502 corresponding to one or more status indicators that were displayed in the graphical element 400. For instance, the selectable elements 502 may be selected to view additional details of the location (e.g., a map of the location such as a map of San Francisco), the availability (e.g., a time window for the current availability status), and/or an impending or in-progress purchase (e.g., including a price and an item corresponding to the purchase) for the contact, Jane. The contact card 500 may further include recent messages received from the contact, Jane.

In an example, upon selection of the selectable element 502, details of the status indicators may be displayed on the electronic device 110. For instance, if the status indicator is of an approval request, then on clicking the selectable element 502, the first user may be displayed an option to perform or approve a transaction to complete the purchase by the contact, Jane, using the first electronic device 110-1.

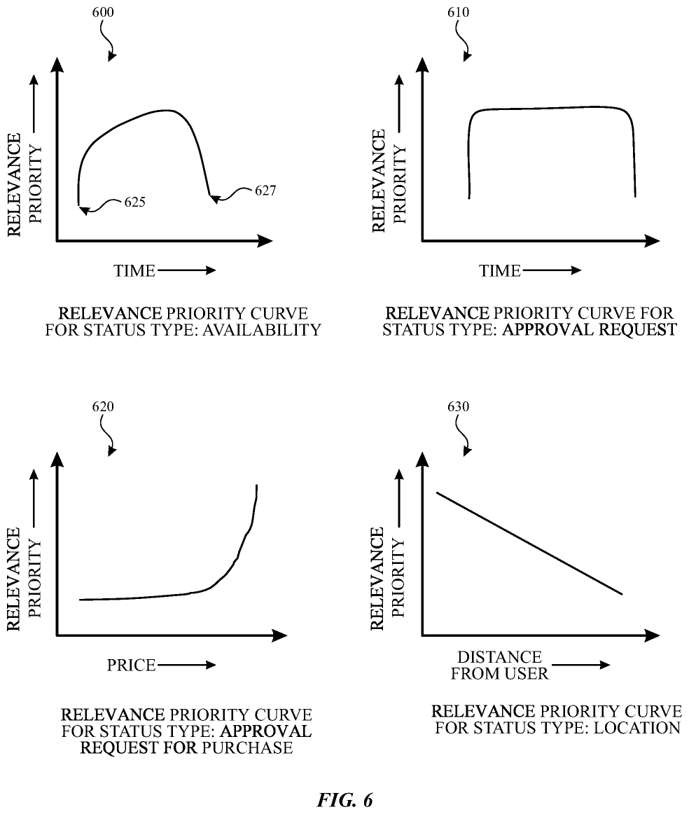

As described herein, the relevance priority of a particular status of a particular contact at a particular time can be determined in order to determine which of several type of statuses of a contact to display, and/or an order in which to display the statuses. FIG. 6 illustrates example relevance priority curves 600, 610, 620, and 630 that illustrate how a relevance priority curve may be used to determine the relevance priority of a status or status indicator that corresponds to a status update, in accordance with one or more implementations of the subject technology. In the example of FIG. 6, relevance priority curves 600 and 610 are each relevance priority curve that show a relevance priority of a corresponding status as a function of time, to indicate when those type of statuses will be relevant and therefore may be selected to be displayed in the graphical element 400.

For example, to obtain a current relevance priority for an availability status of a contact, the point on the relevance priority curve 600 corresponding to the current time may be extracted from the relevance priority curve 600 and used as the relevance priority for the availability status. For example, the time in FIG. 6 for the relevance priority curve 600 may be a time of day, and the contact may be a coworker, and thus the relevance priority curve 600 for the availability of the coworker may rise rapidly at the beginning of the work day, increase throughout the day, and then fall as the work day ends (as one illustrative example).

As another example, to obtain a current relevance priority for an approval request by a contact, the point on the relevance priority curve 610 corresponding to the current time may be extracted from the relevance priority curve 610 and used as the relevance priority for the approval request. For example, the time in FIG. 6 for the relevance priority curve 610 may be a time since the approval was requested, and thus the priority curve 610 for the approval request may step to a high priority when the approval is requested by the contact, and step down to a low relevance priority after a period of time (e.g., when a pending purchase authorization expires after, for example, a few minutes or hours from the time when the approval was requested).

As another example, to obtain a current relevance priority for an approval request, which is an approval request for a purchase in this example, the point on the relevance priority curve 620 corresponds to the price of the purchase that may be extracted from the relevance priority curve 620 and used as the relevance priority for the approval request. In the example of FIG. 6, the relevance priority of an approval request for the purchase by a contact increases (e.g., exponentially) with the purchase price. In one or more implementations, both of the relevance priority curves 610 and 620 may be used (e.g., the extracted priorities from the two curves may be combined using a weighted combination or other combination) to determine a relevance priority for the purchase status.

As another example, to obtain a current relevance priority for a location a contact, the point on the relevance priority curve 630 corresponding to the current distance between the location of the contact and the location of the user (or from a location known to be relevant to the user such as the location of the user's home or the location of the user's work or favorite coffee shop) may be extracted from the relevance priority curve 630 and used as the relevance priority for the location of the contact. In the example of FIG. 6, the relevance priority of the location of the user decreases linearly with increasing distance from the user (as one illustrative example). In one or more implementations, the relevance priority curve 630 may be used in combination with a relevance priority curve for that depends on time since the location of the contact was updated, or a relevance priority curve for that depends on time since the location of the contact was updated may be used to determine the relevance priority of the location of the contact without using the relevance priority curve 630.

It is appreciated that the priority curves of FIG. 6 are illustrative, and that various relevance priority curves can be provided for various types of status updates. In one or more implementations, the relevance priority curves may indicate how long a status update will be relevant to the user of the electronic device 110. In one or more implementations, for each event type, a start relevance priority 625, an end relevance priority 627, and/or one or more other priorities between a start time (e.g., the status update time) and an end time (e.g., the end of the duration in which the status update is relevant) may be used as control points for a Bezier curve to generate the relevance priority curve for a particular status update.

In one or more implementations, the duration between the start time and the end time of the relevance of a status update may be determined based on the type of the status update, and/or based on information associated with the contact or the content of the status update (e.g., the price of an approval request and/or the importance or relevance of a location to the user).

Based on the relative priorities extracted from one or more relevance priority curves such as relevance priority curves 600, 610, 620, and/or 630 for various types of statuses of a contact, electronic device 110 may determine which of the types of statuses meets a threshold for display in the graphical element 400. In an example in which only one type of status can be displayed in the graphical element 400, then the status that has highest relevance priority may be selected to be displayed. In another example in which two types of statuses can be displayed in the graphical element 400, then the statuses with the two highest priorities may be selected to be displayed.

In one or more implementations, the electronic device 110-1 may provide future updates to the graphical element 400 based on the relevance priority curves for several status indicators. For example, the electronic device 110-1 may determine priorities for each of several status indicators at each of several future times, based on the current relevance priority and the upcoming change in relevance priority indicated by a relevance priority curve for that status indicator. The electronic device 110-1 may determine that at a particular future time, a relatively lower relevance priority status indicator will have a relevance priority that overtakes the relevance priority of a currently high relevance priority status indicator, and may generate a graphical element update for reordering the status indicators based on the future priorities, for display in the graphical element 400 at the particular future time.

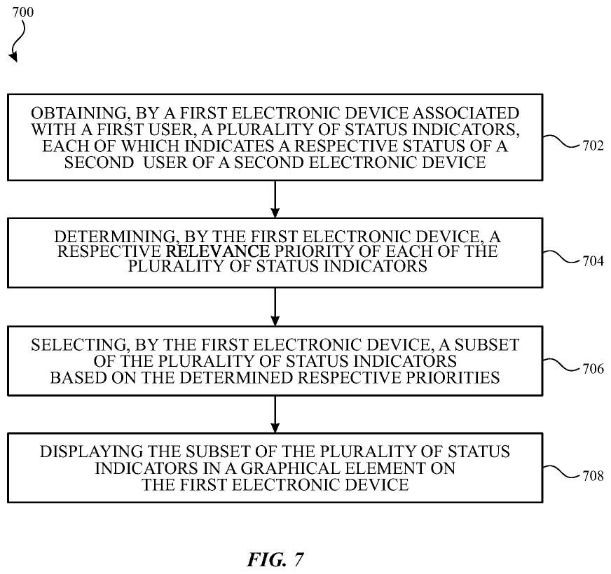

FIG. 7 illustrates a flowchart of a process 700 for context-based user status indicator selection, in accordance with one or more implementations of the subject technology. In an example, the process 700 may be implemented by the system 200. In an example, the process 700 may be implemented in a single electronic device, for example, the electronic device 110. In another example, the process 700 may be implemented in a distributed manner, without departing from the spirit and scope of the present subject matter. Furthermore, details of the operations of the process 700 which are already described herein in the above figures are not included in detail herein. Furthermore, the operations of the process 700 described herein may be implemented at the least by one or more components, for example, the processor 202 of the system 200. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, a first electronic device associated with a first user obtains status indicators, each of which indicates a respective status of a second user of a second electronic device. In an example, the first electronic device 110 may obtain the status indicators corresponding to the second user. In an example, the status indicators may include a location status indicator, an availability status indicator, and an approval request indicator (and/or any other status indicators provided by the second electronic device).

In an example, obtaining a status indicator may include determining the status indicator based on contact data associated with the second user that is stored on the first electronic device. The contact data may include messages, emails, calendars, etc. associated with the second user.

In another example, obtaining a status indicator may include receiving the status indicator from one or more of the second electronic device or a server. For instance, in an example, permission from the second user of the second electronic device may be explicitly provided by the second user to the second electronic device before any status information for the second user is provided to the first electronic device. Accordingly, the first electronic device may obtain the status indicators from the second electronic device and/or the server. The server, in an example, may be any server, such as an email server, a messaging server, a publication server, etc.

At block 704, a respective relevance priority of each of the status indicators is determined by the first electronic device. In an example, for determining the relevance priority, a relevance priority curve (e.g., relevance priority curve 600, 610, 620, or 630 of FIG. 6, or other relevance priority curve) corresponding to a status type of the status indicator may be obtained. In one or more examples, a time associated with the status indicator may also be obtained. The relevance priority may be extracted from the obtained relevance priority curve corresponding to the status type of the status indicator based on the obtained time in some examples. The relevance priority for the status indicator may be determined based on the status indicator and the obtained relevance priority curve corresponding to the status type of the status indicator.

At block 706, a subset of the status indicators is selected by the first electronic device based on the determined respective priorities. In an example, the selection of the subset may be based on a predetermined threshold. For example, in one or more implementations, all of the status indicators having corresponding priorities that are above the threshold may be included in the subset. In other examples, a predetermined number of status indicators may be selected from amongst the status indicators which are above the threshold for including in the graphical element. For instance, top one, two, three or four relevance priority status indicators may be selected for display. In an example, the predetermined number may be based on dimensions of a graphical element in which the status indicators are to be displayed.

At block 708, the subset of the status indicators is displayed in a graphical element (e.g., graphical element 400) by the first electronic device. In an example, the graphical element may be a widget. In said example, the subset of status indicators may be displayed within a contact element (e.g., a contact element 402) in the widget.

In one or more implementations, the process 700 may further include, prior to obtaining the status indicators, recommending, by the electronic device, the second user for inclusion of status information in the graphical element. The recommending may include providing local data associated with users corresponding to contacts stored at the first electronic device as input to a machine-learning model that is trained to determine relevance of the contacts of a user. In one or more implementations, the process 700 may include recommending the second user based on an output of the machine learning model. As an example, the machine-learning model may be trained to determine a relevance of the second user to the first user. For instance, if the input to the machine-learning model indicates that the second user is a family member of a family of the first user, the machine-learning model would determine the relevance of the second user higher in comparison to other users. Accordingly, the machine-learning model may output the second user contact as a suggestion for inclusion in the graphical element, 400 for obtaining and displaying corresponding status indicators.

In one or more implementations, the process 700 may further include receiving an acceptance of the recommendation at the first electronic device. For instance, upon obtaining the output from the machine-learning model suggesting the inclusion of the contact of the second user in the graphical element 400, the first electronic device may display the suggestion (e.g., as shown in FIG. 3) along with an option to accept or reject the recommended contact for the inclusion. Accordingly, the first user may, in an example, select to include the contact of the second user in the graphical element. Furthermore, the process 700 may include obtaining the status indicators after receiving the acceptance. For instance, after receiving the acceptance, the first electronic device may transmit a message including an indicator to initiate receiving of the one or more status indicators to the second electronic device. Subsequently, the first electronic device may obtain, e.g., receive the status indicators from the second electronic device.

In one or more implementations, the process 700 may further include obtaining, by the first electronic device associated with the first user, additional status indicators, each of which indicates a respective additional status of a third user of a third electronic device. The process 700 may further include determining an additional respective relevance priority of each of the additional status indicators. Furthermore, the process 700 may include selecting an additional subset of the additional status indicators based on the determined additional respective priorities. Furthermore, the process 700 may include displaying the additional subset of the additional status indicators in the graphical element on the first electronic device.

FIG. 8 depicts a computing-device based implementation of the system of FIG. 2 in accordance with one or more implementations of the subject technology. The system 800 can be, and/or can be a part of, the electronic device 110, and/or the server 120 shown in FIG. 1. The system 800 may include various types of computer readable media and interfaces for various other types of computer readable media. The system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the system 800. The permanent storage device 802, on the other hand, may be a read-and-write memory device. The permanent storage device 802 may be a non-volatile memory unit that stores instructions and data even when the system 800 is off. In one or more implementations, a mass-storage device (such as a magnetic or optical disk and its corresponding disk drive) may be used as the permanent storage device 802.

In one or more implementations, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input and output device interfaces 814 and 806. The input device interface 814 enables a user to communicate information and select commands to the system 800. Input devices that may be used with the input device interface 814 may include, for example, alphanumeric keyboards and pointing devices (also called “cursor control devices”). The output device interface 806 may enable, for example, the display of images generated by the system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the system 800 to one or more networks and/or to one or more network nodes, such as the electronic device 110 shown in FIG. 1, through the one or more network interface(s) 816. In this manner, the system 800 can be a part of a network of computers (such as a LAN, a wide area network (“WAN”), or an Intranet, or a network of networks, such as the Internet. Any or all components of the system 800 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM.

The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

The present disclosure recognizes that the use of personal information data, in the present technology, can be used to the benefit of users. For example, the personal information can be used in status or status indicators. Further, other uses for personal information data that benefit the user are also contemplated by the present disclosure. For instance, image of users, health and fitness related status, location status, or the like may be exchanged and used for status indication operations.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of status indication operation, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementation or embodiments, the present disclosure also contemplates that the various embodiments can also be implemented without the need for accessing such personal information data. That is, the various embodiments of the present technology are not rendered inoperable due to the lack of all or a portion of such personal information data.

In accordance with aspects of the disclosure, a method is provided that includes obtaining, by a first electronic device associated with a first user, a plurality of status indicators, each of which indicates a respective status of a second user of a second electronic device and determining, by the first electronic device, a respective relevance priority of each of the plurality of status indicators. Further, the method includes selecting, by the first electronic device, a subset of the plurality of status indicators based on the determined respective priorities and displaying the subset of the plurality of status indicators in a graphical element on the first electronic device.

In accordance with other aspects of the disclosure, a system is provided that includes a processor; and a memory device containing instructions, which when executed by the processor, cause the processor to: obtain a plurality of status indicators, each of which indicates a respective status of a second user of a second electronic device and determine a respective relevance priority of each of the plurality of status indicators. Based on the determined respective priorities, a subset of the plurality of status indicators are selected and displayed in a graphical element on the first electronic device.

In accordance with other aspects of the disclosure, a non-transitory machine-readable medium is provided that includes code that, when executed by a processor, causes the processor to perform a method, the method including obtaining, by a first electronic device associated with a first user, a plurality of status indicators, each of which indicates a respective status of a second user of a second electronic device and determining, by the first electronic device, a respective relevance priority of each of the plurality of status indicators. Further, the method includes selecting, by the first electronic device, a subset of the plurality of status indicators based on the determined respective priorities and displaying the subset of the plurality of status indicators in a graphical element on the first electronic device.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
obtaining, by a first electronic device associated with a first user, a plurality of status indicators, each of which indicates a respective status of a second user of a second electronic device;
determining, by the first electronic device, a respective relevance priority of each of the plurality of status indicators;
selecting, by the first electronic device, a subset of the plurality of status indicators based on the determined respective priorities; and
displaying the subset of the plurality of status indicators in a graphical element on the first electronic device.

2. The method of claim 1, wherein determining the respective relevance priority of each of the status indicators comprises:
obtaining a relevance priority curve corresponding to a status type of the status indicator; and
determining the relevance priority for the status indicator using the status indicator and the obtained relevance priority curve corresponding to the status type of the status indicator.

3. The method of claim 2, wherein determining the relevance priority for the status indicator using the status indicator and the obtained relevance priority curve corresponding to the status type of the status indicator comprises:
obtaining a time associated with the status indicator; and
extracting the relevance priority from the obtained relevance priority curve corresponding to the status type of the status indicator using the time.

4. The method of claim 1, wherein the plurality of status indicators includes a location status indicator, an availability status indicator, and a purchase indicator.

5. The method of claim 1, further comprising:
obtaining, by the first electronic device associated with the first user, a plurality of additional status indicators, each of which indicates a respective additional status of a third user of a third electronic device;
determining an additional respective relevance priority of each of the additional status indicators;
selecting an additional subset of the plurality of additional status indicators based on the determined additional respective priorities; and
displaying the additional subset of the plurality of additional status indicators in the graphical element on the first electronic device.

6. The method of claim 1, further comprising, prior to obtaining the plurality of status indicators:
recommending, by the first electronic device, the second user for inclusion of status information in the graphical element;
receiving an acceptance of the recommendation at the first electronic device; and
obtaining the plurality of status indicators after receiving the acceptance.

7. The method of claim 6, wherein recommending the second user comprises:
providing local data associated with a plurality of users associated with a plurality of contacts stored at the first electronic device as input to a machine-learning model trained to determining significance of the contacts of a user; and
recommending the second user based on an output of the machine learning model.

8. A system implementable in a first electronic device associated with a first user, the system comprising:
a processor; and
a memory device containing instructions, which when executed by the processor, cause the processor to:
obtain a plurality of status indicators, each of which indicates a respective status of a second user of a second electronic device;
determine a respective relevance priority of each of the plurality of status indicators;
select a subset of the plurality of status indicators based on the determined respective priorities; and
display the subset of the plurality of status indicators in a graphical element on the first electronic device.

9. The system of claim 8, wherein the memory device contains further instructions, which when executed by the processor, cause the processor to:
obtain a relevance priority curve corresponding to a status type of the status indicator; and
determine the relevance priority for the status indicator using the status indicator and the obtained relevance priority curve corresponding to the status type of the status indicator.

10. The system of claim 9, wherein the memory device contains further instructions, which when executed by the processor, cause the processor to:
obtain a time associated with the status indicator; and
extract the relevance priority from the obtained relevance priority curve corresponding to the status type of the status indicator using the time.

11. The system of claim 8, wherein the plurality of status indicators includes a location status indicator, an availability status indicator, and a purchase indicator.

12. The system of claim 8, wherein the memory device contains further instructions, which when executed by the processor, cause the processor to:
obtain a plurality of additional status indicators, each of which indicates a respective additional status of a third user of a third electronic device;
determine an additional respective relevance priority of each of the additional status indicators;
select an additional subset of the plurality of additional status indicators based on the determined additional respective priorities; and
display the additional subset of the plurality of additional status indicators in the graphical element on the first electronic device.

13. The system of claim 8, wherein the memory device contains further instructions, which when executed by the processor, cause the processor to, prior to obtaining the plurality of status indicators:
recommend the second user for inclusion of status information in the graphical element;
receive an acceptance of the recommendation at the first electronic device; and
obtaining the plurality of status indicators after receiving the acceptance.

14. The system of claim 13, wherein the memory device contains further instructions, which when executed by the processor, cause the processor to:
provide local data associated with a plurality of users associated with a plurality of contacts stored at the first electronic device as input to a machine-learning model trained to determine relevance of the contacts of a user; and
recommend the second user based on an output of the machine learning model.

15. A non-transitory machine-readable medium comprising instructions that, when executed by a processor, cause the processor to perform operations comprising:
obtaining, by a first electronic device associated with a first user, a plurality of status indicators, each of which indicates a respective status of a second user of a second electronic device;
determining, by the first electronic device, a respective relevance priority of each of the plurality of status indicators;
selecting, by the first electronic device, a subset of the plurality of status indicators based on the determined respective priorities; and
displaying the subset of the plurality of status indicators in a graphical element on the first electronic device.

16. The non-transitory machine-readable medium of claim 15, wherein the operations further comprise:
obtaining a relevance priority curve corresponding to a status type of the status indicator; and
determining the relevance priority for the status indicator using the status indicator and the obtained relevance priority curve corresponding to the status type of the status indicator.

17. The non-transitory machine-readable medium of claim 16, wherein the operations further comprise:
obtaining a time associated with the status indicator; and
extracting the relevance priority from the obtained relevance priority curve corresponding to the status type of the status indicator using the time.

18. The non-transitory machine-readable medium of claim 15, wherein the operations further comprise:
obtaining, by the first electronic device associated with the first user, a plurality of additional status indicators, each of which indicates a respective additional status of a third user of a third electronic device;
determining an additional respective relevance priority of each of the additional status indicators;
selecting an additional subset of the plurality of additional status indicators based on the determined additional respective priorities; and
displaying the additional subset of the plurality of additional status indicators in the graphical element on the first electronic device.

19. The non-transitory machine-readable medium of claim 15, wherein the operations further comprise:
recommending, by the first electronic device, the second user for inclusion of status information in the graphical element;
receiving an acceptance of the recommendation at the first electronic device; and
obtaining the plurality of status indicators after receiving the acceptance.

20. The non-transitory machine-readable medium of claim 15, wherein the operations further comprise:
providing local data associated with a plurality of users associated with a plurality of contacts stored at the first electronic device as input to a machine-learning model trained to determining relevance of the contacts of a user; and
recommending the second user based on an output of the machine learning model.
